(19) United States
(12) Patent Application Publication
(10) Pub. No.: US 2008/0183934 A1
(43) Pub. Date: Jul. 31, 2008

(54) OPTIONAL MOBILE MEDIA STORAGE SYSTEM

(75) Inventors: Matthew Thomas Starr, Lafayette, CO (US); Richard Douglas Rector, Arvada, CO (US); Mark Lorin Lantry, Erie, CO (US); John David Barr, Superior, CO (US); Nathan Christopher Thompson, Boulder, CO (US)

Correspondence Address: SPECTRA LOGIC;c/o HISCOCK & BARCLAY, LLP, 100 CHESTNUT STREET, 2000 HSBC PLAZA, ROCHESTER, NY, 14604-2404, US

(73) Assignee: Spectra Logic Corporation, Boulder, CO (US)

(21) Appl. No.: 12/058,228

(22) Filed: Mar. 28, 2008

Related U.S. Application Data
(63) Continuation-in-part of application No. 11/735,204, filed on Apr. 13, 2007.
Application No. 11/735,204 is a continuation of application No. 11/011,812, filed on Dec. 14, 2004, now Pat. No. 7,253,983.
Application No. 11/011,812 is a continuation-in-part of application No. 11/230,146, filed on Sep. 19, 2005.

(51) Int. Cl. G06F 13/00

(52) U.S. Cl. 710/303

(57) ABSTRACT

A data storage system that retrieves and stores data to a mobile random access memory device that can virtually function as any number of variable storage media is accomplished by a switching means linked to the mobile random access memory device. The storage system generally possesses at least one mobile random storage device, at least one docking station that cooperates with the mobile random storage device to store data for a host computer, and a switching means linked to the docking station. The switching means can switch an identification associated with the docking station to a virtual tape library system, wherein a switching function of the switching means may or may not be initiated by the host computer.

### CROSS-REFERENCE TO RELATED APPLICATIONS

This application is a Continuation-in-Part Application of U.S. Ser. No. 11/735,204, entitled VARIABLE MOBILE MEDIA STORAGE SYSTEM, filed Apr. 13, 2007 which is a continuation of U.S. Ser. No. 11/011,812, filed Dec. 12, 2004 and U.S. Ser. No. 11/230,146, entitled VIRTUAL INTERCHANGEABLE DEVICE, filed on Sep. 19, 2005 which are incorporated herein by reference.

### BACKGROUND OF THE INVENTION

1. Field of the Invention

The present invention relates generally to retrieving data from, and storing data to, a variable medium storage system by means of communications intended for a tape library.

2. Description of Related Art

Tape libraries have historically been used as primary storage devices for amassed digital data. This has been due, in part, to the considerable amounts of data that can be stored in a cost-efficient manner. Alternative storage systems, such as disc drives, optical storage systems, and flash memory are gaining momentum. These alternative storage systems take advantage of random access memory storage functionality which can dramatically speed up data transfer between a host and the storage system. Virtual Tape Libraries (VTLs) generally possess fixed disc drives that often take the form of contiguous storage capacity. Though most VTLs can be updated with increasing storage capacity, which may include adding more disc drives or swapping low capacity disc drives with higher capacity disc drives, the disc drives are, nonetheless, considered fixed because such disc drives are manually installed in a VTL often with screws or other attaching means.

Generally, a host computer is adapted to store, retrieve, and manipulate data with specific types of storage systems comprising specific types of storage devices operable to manage data on specific types of storage media. Such storage operations are typically accomplished by using a specific data storage protocol compatible with a specific type of storage system. For example, when a host computer is adapted to store data in a tape library, communication and data transfer between the tape library and the host is typically accomplished by a tape library protocol. Some storage systems that leverage disc drive storage technology are configured to emulate a tape library and store data received from the host as if they were a tape library by communicating with the host via the tape library protocol. Such advances are evident in VTLs, which emulate tape protocols with unique data storage protocols that take advantage of the random access nature of the disc drives.

Though systems like VTLs have virtues such as improved data transfer, speed, and redundant storage backup using RAID, they are often limited to a fixed storage capacity, unlike the tape libraries, which can use a mobile, restorable supply of tape cassettes. In most cases, VTLs can be updated with increased storage capacity, which may include adding more fixed disc drives or swapping low capacity disc drives with higher capacity disc drives. Increasing capacity in this manner generally depends on manually installing disc drives in the VTL, often by removing VTL covers and screwing/unscrewing disc drives from disc drive shelves in the VTLs. Therefore, such VTLs are considered fixed storage devices because they are not adapted for mobility in a manner that is similar to systems employing tape cassettes. In addition, conventional storage systems, such as the VTL, are further restricted to a specific data storage protocols for storing data.

In an effort to provide an improvement in versatility for storing and retrieving data with a host computer coupled with replenishable and truly mobile storage devices, both methods and apparatus are proposed herein. It is to innovations related to this subject matter that the claimed invention is generally directed.

### SUMMARY OF THE INVENTION

The present invention relates generally to retrieving data from and storing data to a variable medium storage system by means of communications intended for a tape library. The invention overcomes the disadvantages and limitations of the prior art by providing a method and apparatus for directing data storage intended for a target tape article and target tape drive associated with the tape library to a selected mobile storage element and drive pair associated the storage system.

Embodiments of the present invention can therefore comprise A storage system comprising: an interface processor device that interfaces between the storage system and a host; a first mobile storage element; a first docking station adapted to receive the first mobile storage element to form a functional pair wherein the functional pair can perform storage operations; a switch system capable of switching the first docking station to appear virtually to the host as a first tape storage system; a map system that is adapted to map the first docking station as either the docking station or the virtual tape storage system based on the switching state of the switch system.

Another embodiment of the present invention can therefore comprise a method for using a storage system comprising: providing a first and a second docking station and a first mobile storage element; switching an identification associated with the first docking station; loading the first mobile storage element in a cooperating operational relationship with the first docking station after the switching step; mapping the first loaded docking station as a virtual tape library based on the switching identification step.

Yet another embodiment of the present invention can therefore comprise a data storage system comprising: at least one mobile storage element; at least one docking station that includes a means for cooperating with an associated one of the at least one mobile storage element to store data for a host computer; a switching means linked to the at least one docking station for switching an identification associated with the at least one docking station to a virtual tape library, wherein a switching function of the switching means is not initiated by the host.

### BRIEF DESCRIPTION OF THE DRAWINGS

FIG. 1 is a block diagram of a data storage arrangement constructed in accordance with an embodiment of the present invention.

FIG. 2 shows a perspective illustration of a storage system wherein the present invention can be practiced in accordance with some embodiments of the present invention.

FIG. 3 shows an exploded illustration of an embodiment of a commercial disc drive magazine and docking station wherein the present invention can be practiced in accordance with some embodiments of the present invention.

FIGS. 4A and 4B are block diagrams showing virtual storage devices with respective virtual media associated with a docking station consistent with some embodiments of the present invention.

FIGS. 5A and 5B are block diagrams illustrating a host computer communicating with a storage system consistent with an embodiment of the present invention.

FIG. 6 is a block diagram showing an alternative embodiment with two docking stations receiving and responding to storage operations from a host computer FIG. 7 is a block diagram showing yet another alternative embodiment with two docking stations receiving and responding to storage operations from a host computer.

FIG. 8 a block diagram showing two different host computers performing coincidental storage operations with a storage system consistent with some embodiments of the present invention.

FIG. 9A is a block diagram illustrating a method of practicing an embodiment of the present invention.

FIG. 9B is a block diagram showing a storage system illustrating methods described in conjunction with FIG. 9A consistent with some embodiments of the present invention.

FIGS. 10A and 10B are block diagrams illustrating embodiments wherein the present invention can be commercially practiced.

### DETAILED DESCRIPTION

This application is a Continuation-in-Part Application of U.S. Ser. No. 11/735,204, entitled VARIABLE MOBILE MEDIA STORAGE SYSTEM, filed Apr. 13, 2007, which is a continuation of U.S. Ser. No. 11/011,812, filed Dec. 12, 2004, and U.S. Ser. No. 11/230,146, entitled VIRTUAL INTERCHANGEABLE DEVICE, filed on Sep. 19, 2005, the subject matter of which are incorporated herein by reference.

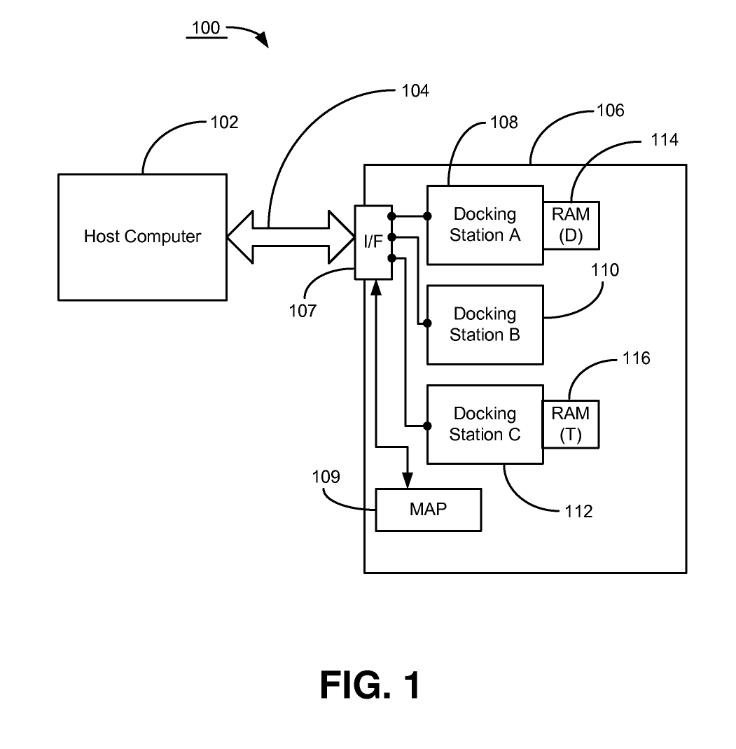

Referring to the drawings in general, and more specifically to FIG. 1, shown therein is a block diagram of a data storage arrangement 100 constructed in accordance with an embodiment of the present invention. In what follows, similar or identical structure is identified using identical callouts.

The data storage arrangement 100 includes a host computer 102 in communication 104 with a storage system 106 via an interface processor device 107. A host computer 102 is one exemplary embodiment of a consumer of data; other embodiments can also include another storage system 106 or a streaming output device such as a video server, just to name several examples. A consumer of data is an entity, or entities, that are capable of “taking in” data. For example, a host computer 102 is a consumer of data when receiving data, and a storage system 106 is a consumer of data when receiving data. As one skilled in the art will appreciate, in addition to “taking in” data, a consumer of data is also generally capable of transmitting data. The host computer 102 can be a personal computer, a main frame computer, a server, or any computer system capable of communication with the storage system 106, just to name a few examples. The communication path 104 facilitates communication between the host computer 102 and the storage system 106. The means for communication can be accomplished by a dedicated pathway (such as a SCSI [Small Computer Systems Interface] cabled connection) or, in an alternative embodiment, a pathway over a network (such as a LAN, WAN, or other communication architecture), for example. Furthermore, the communication path 104 can be in the form of a wire line pathway, wireless, or a combination thereof, for example.

The storage system 106 is capable of storing and retrieving data for the host 102 by means of using at least one docking station, such as docking station A 108, docking station B 110 and docking station C 112 via the interface processor device 107 that is linked to the docking stations 108, 110 and 112. Docking stations A 108 and C 112 are each operatively linked with mobile Random Access Memory (RAM) devices 114 and 116, respectively, wherein the mobile RAM devices 114 and 116 are each adapted to store data received from the host computer 102 via the relative docking stations 108 and 112. A RAM device is capable of storing random data, which is data that is not constrained by a linear format such as tape, for example. In one exemplary embodiment, the mobile RAM device 114 is illustratively shown inserted in docking station A 108 wherein the mobile RAM device 114 is operatively linked to docking station A 108 in a cooperating data storage relationship. A cooperating data storage relationship is one wherein data storage operations are carried out between a RAM device and a docking station, for example, with data written to and read from a RAM device via a docking station. A docking station is an apparatus that is adapted to receive a mobile RAM device in a docking relationship. A docking relationship between a docking station and a mobile RAM device allows for cyclical electrical and data transferring connections with the intention to use the mobile RAM device for mobile purposes, hence, either the docking station and/or the mobile RAM device are adapted for the cyclical connections, such as with a pin and pad contact arrangement, for example. This docking relationship is in contrast to storage devices that are not constructed or adapted for mobility, such as standard disc drives, which are typically plugged into an electrical and data transferring cable, and which once installed, are generally retained in place. Storage capacity in storage related systems, such as a VTL, is often increased by adding more standard storage devices, such as disc drives that are not altered or adapted for mobility, or swapping low capacity standard storage devices with higher capacity standard storage devices. Adding or swapping standard storage devices does not categorize the standard storage devices as mobile RAM devices because they are not adapted to be mobile, such as with the intention to be cyclically connected and moved within or outside of a library with frequency. Rather, standard storage devices are installed, typically by labor intensive operations, generally with the intention of being left in place, that is, substantially immobile, often without any further alteration.

With continued reference to FIG. 1, as illustratively shown, docking station B 110 is not operatively linked with a mobile RAM device and hence is unable to store data received beyond any storage capacity that docking station B 110 may possess, such as Dynamic RAM, for example. For purposes of illustration, communication with the storage system 106 is considered communication with the interface processor device 107 and/or the storage related components that the storage system 106 possesses. A docking station, such as docking station A 108, is an apparatus that is capable of coupling with a mobile RAM device, such as mobile RAM device 114, for storage operations. Several examples of a docking station include a USB port capable of receiving a USB device, a PCMCIA slot for receiving a PC-card, a disc drive or disc drive magazine receptacle, serial port connection, parallel port connection, or any other such apparatus capable of transmitting and receiving data to a storage device via wire line or wireless, just to name several examples.

As illustratively shown, mobile RAM device 114 is designated with a (D) which represents that docking station A 108, when coupled with mobile RAM device 114, appears to the host 102 as a disc drive storage device that is ready to engage in disc drive related storage operations with the host 102, whereas, mobile RAM device 116 is designated with a (T) which represents that docking station C 112, when coupled with mobile RAM device 116, appears, virtually, to the host 102 as a tape storage system that is ready to engage in tape related storage operations with the host 102. In one embodiment, the storage system 106 further comprises a mapping system 109 that is connected to the interface processor device 107, wherein the host 102 accesses the map system to identify the storage devices that are (in some cases, virtually) present with the storage system 106. The map system 109 maps docking station A 108 as a disc drive storage device that is ready to engage in disc drive related storage operations with the host 102, docking station B 110 as a storage system not available for storage operations, and docking station C 112 a tape storage system (in the virtual sense) ready engage in tape related storage operations with the host 102. As will be discussed later, either a mobile RAM device or docking station can be switched to appear as a disc drive system or a tape storage system.

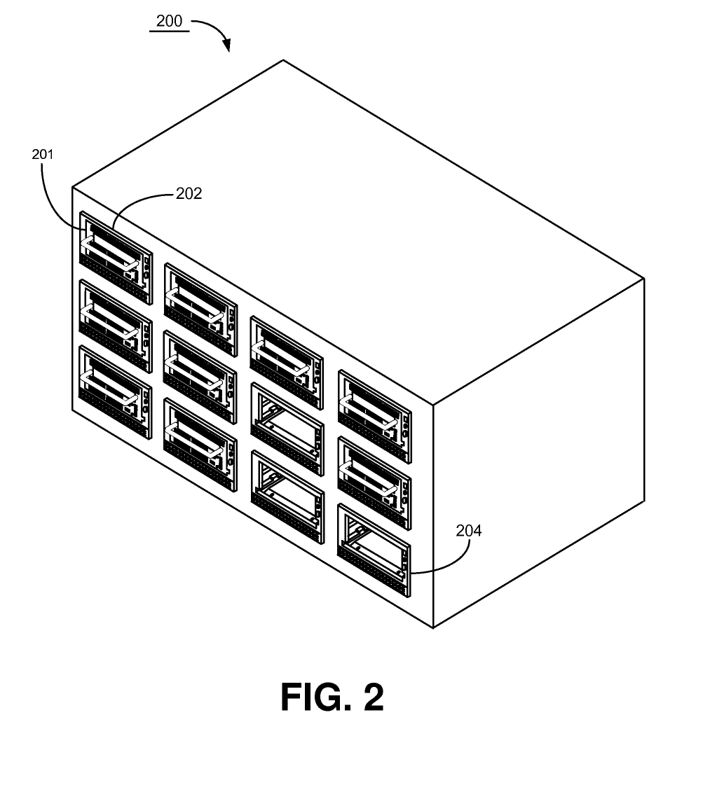

FIG. 2 shows a commercial embodiment of a storage system 106 in accordance with one embodiment of present invention. Here, an RXT Bank-of-Drives disc drive magazine library 200 from Spectra Logic Corporation of Boulder, Colo. comprises a plurality of disc drive magazines 201 and docking stations 202 wherein the docking stations 202 are operatively linked to one another to function as the RXT library 200. The disc drive magazines 201 are adapted for mobility, and can be removed from or inserted into a docking station 202, as illustrated by a vacant docking station 204 capable of receiving a disc drive magazine 201, for example. The RXT library 200 is capable of communicating with a host, such as the host 102, either via a sequential storage protocol, such as a tape library protocol used for streaming data to store on tape medium, for example, or standard disc drive protocol. In one optional embodiment, the RXT library 200 can be configured to communicate with a host via any protocol desired by an end user.

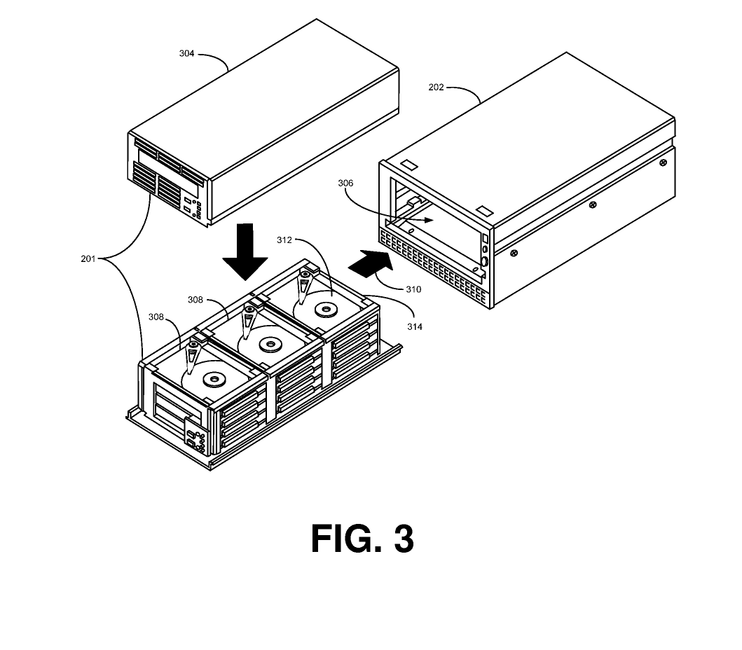

FIG. 3 shows a more detailed illustration of an embodiment of an RXT disc drive magazine 201 and docking station 202. Here, a plurality of disc drives 308 are shown substantially contained by an enclosure 304 which together generally comprise the mobile disc drive magazine 201. A conventional magnetic disc drive 308 is only one embodiment of a RAM device which can be adapted for mobility via intermediate mechanical attachments or ancillary devices, such as flexible conductive pins used with conductive pads, for example. In optional embodiments, a RAM device can include flash memory or optical memory, just to name a few (see below) that can be adapted for mobility. Also, illustratively shown, the docking station 202 provides a means for cooperating with the RXT disc drive magazine 201 via an opening 306 in the face of the docking station 202. The mobile disc drive magazine 201 is adapted to be received by the opening 306 in the docking station 202 as shown by the arrow 310. While the docking station 202 is shown as one of a number of stations in the library 200, one of ordinary skill will appreciate that the docking station 202, by itself, could be used as a stand-alone storage system. The engaging surface 314 of the mobile disc drive magazine 201 is adapted with electrical contacts (not shown) to contact with complementary electrical contacts (not shown) on the engaging surface (not shown) of the docking station 202. The electrical contact configuration supports the mobility of the RXT disc drive magazine 201 by facilitating cyclic docking and undocking of the RXT disc drive magazine 201 with the docking station 202. Suitable contacts may be those disclosed in U.S. Application Number 20060134997. When contact is made, the RXT disc drive magazine 201 is considered operatively linked with the docking station 202 whereby the transmission of data can occur between the docking station 202 and the mobile disc drive magazine 201. Furthermore, power can be optionally provided to the mobile disc drive magazine 201 by the docking station 202. Power and data transmission provide a cooperatively linked state between the mobile disc drive magazine 201 and the docking station 202. The docking station 202 is capable of being communicatively connected with a host computer, such as the host computer 102, or other storage device/s, such as the RXT storage library 200 for example, by a coupling means, such as wires, plugs-in, wireless transmission (e.g., IR, RF) or any combination or equivalence thereof. By linking the docking station 202 with the storage system 200, a connected disc drive magazine 201 is effectively in a cooperatively linked state with the storage system 200.

While the claimed invention has utility in any number of different applications, the RXT disc drive magazine library 200 is referenced to illustrate a suitable environment in which the claimed invention can be practiced. Here, the disc drive magazine 201 is an embodiment of a mobile RAM device, such as RAM device 114. Other mobile RAM devices can include a Compact Disc Read Only Memory (CDROM) for use with a Compact Disc (CD) or other optical storage media, magneto optical systems, disc drives altered for mobility, disc drive magazine comprising multiple disc drives, flash memory devices (such as a compact flash) adapted for mobility, floppy disc drive systems, and RAM semiconductor memory adapted for mobility (i.e., an SDRAM, for example).

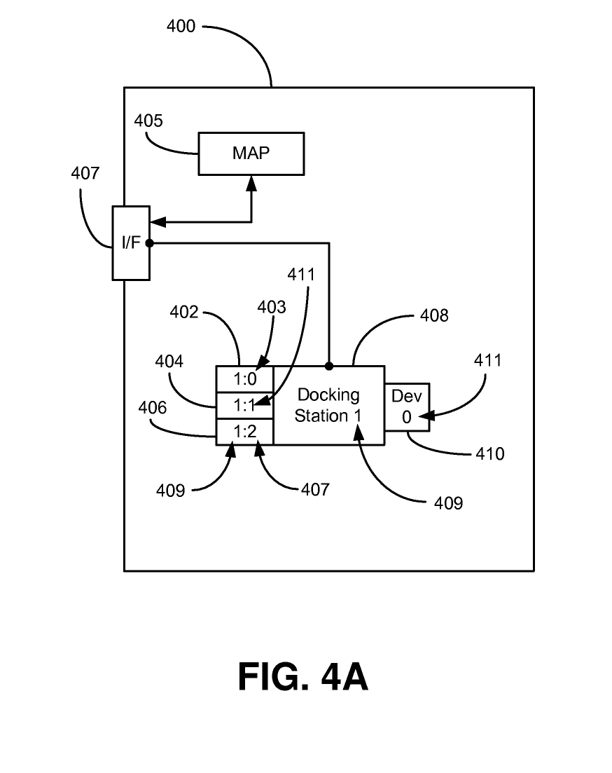

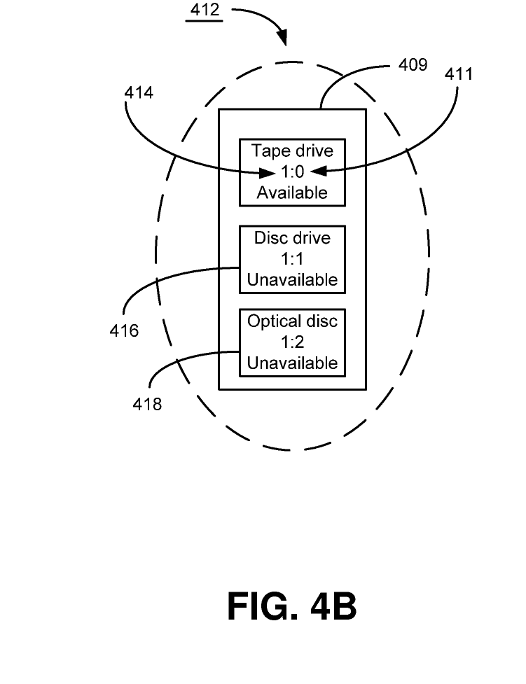

FIGS. 4A and 4B are block diagrams showing an embodiment of virtual storage devices with respective virtual media 412 associated with a docking station 408 consistent with an embodiment of the present invention. Referring to FIG. 4A, a storage system 400 comprises a single docking station [1] 408 wherein the docking station [1] 408 is associated with address [1] 409. Docking station [1] 408 further comprises three sub-addresses that correspond to virtual devices, shown herein as [0] 403, [1] 411 and [2] 407. Herein, the convention used to show address and sub-address is illustrated by the address:sub-address blocks 1:0 402, 1:1 404 and 1:2 406. In one commercial embodiment, the sub-addresses [0] 403, [1] 411 and [2] 407 can be Logical Unit Numbers (LUNs). Both the address [1] 409 and sub-addresses [0] 403, [1] 411 and [2] 407 are capable of being identified by a host computer, such as the host computer 102 of FIG. 1. As shown here, docking station [1] 408 is operatively linked with a mobile RAM device 410. The mobile RAM device 410 is designated as a device corresponding to sub-address [0] 411. Hence, address:sub-address 1:0 402 corresponds to the docking station address [1] 409 and the mobile RAM device designated sub-address [0] 411. Designating the mobile RAM device 410 to a specific virtual storage device can be accomplished by a switch system which could, for example, include a manual switch, an RF driven switch, a programmable switch, an auto switch activated by communication with a host computer, or a time based switch (such that, for example, during daytime the mobile RAM device 410 is one virtual device and at nighttime the mobile RAM device 410 is an alternative virtual device), just to name a few examples. In some embodiments, the switch system could be disposed on or in the mobile RAM device 410. In an alternative embodiment, the mobile RAM device 410 could auto switch to a particular virtual storage device activated by communication with a host computer, such as host computer 102 (i.e., the mobile RAM device 410 can configure itself as device [0] 411, for example, if an inquiry by a host computer requiring storage on a device [0] 411 is received by the cooperating docking station 408). In yet another alternative embodiment, the switch system can control the docking station 408 such that the docking station 408 is designated to belong to a specific virtual storage device and wherein the switch system can be disposed on the docking station or, optionally, in a location external to the docking station similarly as discussed in conjunction with the switch embodiments relative to the mobile RAM device 410. As illustratively shown, the docking station 408 is linked to the interface processor device 407 and, subsequently, linked to the mapping system 405. The mapping system 405 can map the storage system 400 to a host in the arranged configuration. One embodiment of a map is shown in FIG. 4B.

FIG. 4B shows a map of docking station 412 representing the docking station 408 at address [1] 409 consistent with embodiments of the present invention. The three address:sub-address blocks 1:0 402, 1:1 404 and 1:2 406, and more specifically the sub-addresses [0] 403, [1] 411 and [2] 407, correspond to three different storage device types capable of storing data on three respective storage medium types. As can be appreciated by a skilled artisan, two of the three (or three of the three) storage devices can be, essentially, identical devices. In this example, sub-address [0] 403 from block 1:0 402 corresponds to a virtual tape storage system 414, sub-address [1] 411 from block 1:1 404 corresponds to a disc drive system 416 and sub-address [2] 407 from block 1:2 406 corresponds to a virtual optical disc system 418 capable of cooperating with at least one virtual removable optical disc for storage operations. The convention used in FIG. 4B will generally be propagated throughout the description for convenience; however, this is only an example convention and can ultimately be whatever a user of the storage system 400 desires. The virtual tape storage system can be merely one or two virtual tape drives with access to one or more virtual tape media or, optionally, a virtual tape library with access to multiple virtual tape cassettes. As shown, the operatively linked mobile RAM device 410 corresponds to sub-address [0] 411, wherein the mobile RAM device 410 may be designated manually by a switch or, optionally, configured to be designated by a controller device, for example. Docking station [1] 408 is, therefore, configured to be responsive to a host computer, such as host computer 102, as available for storage operations as a tape storage system 414. The host computer 102 may used the map system 405 to identify that the docking station 408 and mobile RAM device 410 are functionally operational as a tape storage system. (The disc drive system 416 and the virtual optical disc system 418 are unavailable for storage operations in this example.) In one embodiment, the mobile RAM device 410 is capable of emulating a specific device for use with a media in the virtual sense. For example, the disc drive system 416 is adapted to store data received as random data in a random data protocol intended for a disc drive, the virtual tape storage system 414 is adapted to store data received as sequential data in a sequential data protocol, and the virtual optical disc system 418 is adapted to store data received as random data in a random data protocol and format appropriate for an optical disc system. In yet another embodiment, a mobile RAM device can simply function as the mobile RAM device 410 or, optionally, as a virtual RAM device that may be similar but with different capacity or some different physical or operational characteristics.

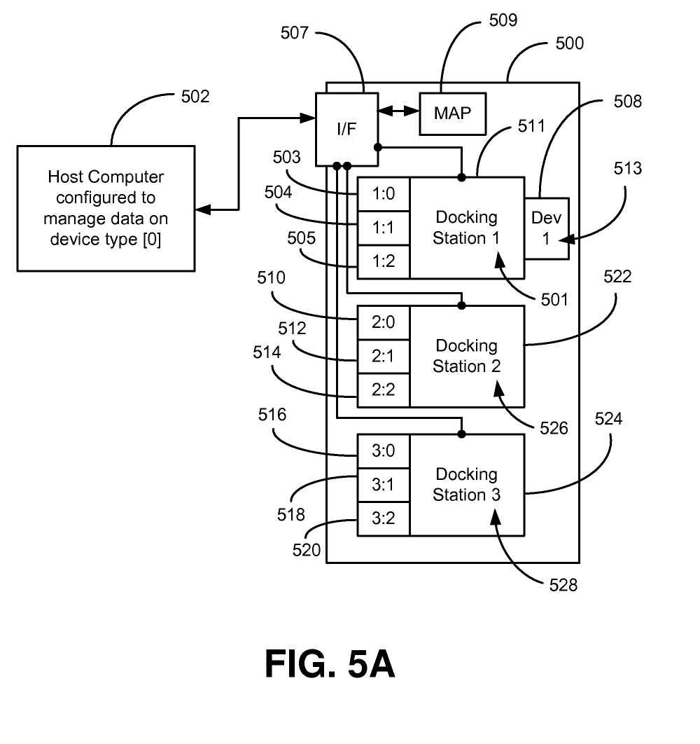

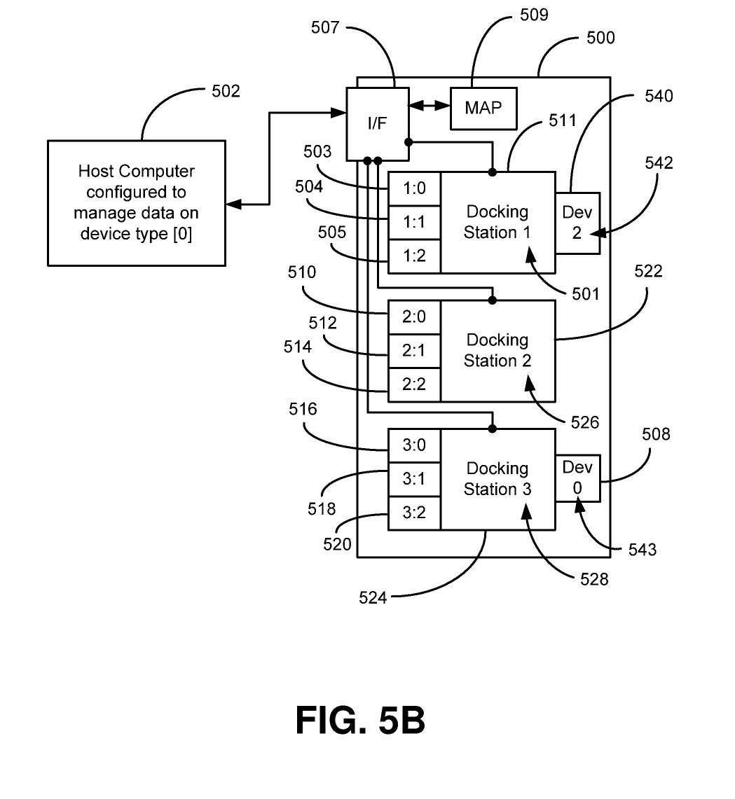

FIGS. 5A and 5B are block diagrams illustrating an embodiment of a host computer 502 communicating 504 with a storage system 500 consistent with an embodiment of the present invention. FIG. 5A shows the storage system 500 comprising three docking stations, docking station [1] 511, docking station [2] 522 and docking station [3] 524. Docking station [1] 511 comprises three address:sub-addresses 1:0 503, 1:1 504 and 1:2 505, docking station [2] 522 comprises three address:sub-addresses 2:0 510, 2:1 512 and 2:2 514, and docking station [3] 524 comprises three address:sub-addresses 3:0 516, 3:1 518 and 3:2 520. Docking station [1] 511 is operatively linked with a mobile RAM device 508 designated as device [0] 543 corresponding to address:sub-address 1:0 503. The host computer 502 is configured to store data on a device [0] 543 and hence is engaged with docking station [1] 511 through the address 1:0 503 via the map system 509 and the interface processor device 507, for storage operations.

FIG. 5A can be used to illustrate one embodiment of the present invention whereby the host computer 502 is configured to manage data at the storage system 500 in a protocol used with a storage device type [0]. Following a convention similar to that used in FIG. 4B, the device for sub-address [0] is a virtual tape storage system 414, sub-address [1] is a virtual (or “as is”) disc drive system 416 and sub-address [2] is a virtual optical disc system 418. In this embodiment, the mobile RAM device 540 is designated as a virtual disc drive 416 (which as previously described could be a real disc drive) operatively linked with docking station [1] 511. The host computer 502 can transmit a Small Computer Systems Interface (SCSI) inquiry to scan the storage system's bus (not shown) to discover what devices comprise the storage system 500. Optionally, the map system 509 can provide the information directly to the host computer 502. An inquiry can be a host computer 502 or a user effectively asking the storage system 500 “who are you?” and “what are you?” The storage system 500 can show that there are three devices at address [1] 501, corresponding to docking station [1] 511; a disc drive 416 at address:sub-address 1:1 504, a tape drive system 414 at address:sub-address 1:0 503 and an optical drive system 418 at address:sub-address 1:2 505. The storage system 500 is also capable of showing that address:sub-address 1:1 504 is available for storage operations while addresses 1:0 503 and 1:2 505 are not available for storage operations. In some commercial applications, this can be accomplished by transmitting a SCSI ID:LUN (corresponding to address:sub-address) response to the host computer 502 in 16 bytes of information. Furthermore, the devices corresponding to the address:sub-addresses 2:0 510, 2:1 512, 2:2 514, 3:0 516, 3:1 518 and 3:2 520 corresponding to docking stations [2] 522 and [3] 524, respectively, will all register as unavailable for storage operations to the host computer 502 because there are no mobile RAM devices operatively linked with the docking stations [2] 522 and [3] 524. Once the host computer 502 (configured to store data on a disc drive for example) determines that a tape storage system (in a virtual sense) is available for storage operations at address 1:1 504, storage operations can commence with docking station [1] 511 and the mobile RAM device 508. Depending on the configuration of the RAM device, in this case [1] 513 and the docking station [1] 511, the virtual disc drive storage system can be presented as a tape library available to store data in disc drive format. In an optional embodiment, if the mobile RAM device 508 is designated as device type [0], which is a tape storage system (using the convention of FIG. 4B), the virtual tape storage system can be presented as a tape library available to store data in access one or more target tape cartridges, a plurality of virtual tape drives, such as in a library partition, available to access one or more target tape cartridges, or a single tape drive available and ready to access one or more target tape cartridges. Upon a request from the host computer 502 to commence with storage operations using a target tape drive and a target tape cartridge, the virtual tape storage system at address:sub-address [1:0] will communicate to the host computer 502 (in a virtual sense) that a tape library robotic system has accessed a target tape cartridge, has inserted the target tape cartridge, and is ready for storage operations to commence.

FIG. 5B shows an alternate embodiment of the present invention of the host computer 502 performing storage operations via docking station [3] 524. In this embodiment a second mobile RAM device 540 is operatively linked with docking station [1] 511 of the storage system 500 and the first mobile RAM device 508 is operatively linked with docking station [3] 524. The host computer 502 is configured to perform storage operations with a device type [0]. Through inquiries, the host computer 502 can discover that address:sub-address 1:2 505 of docking station [1] 511, is available for data storage on a device type [2] because mobile RAM device 540 and/or the docking station [1] has been designated to be a device type [2] 542. The host computer 502 can further discover that all of the addresses associated with docking station [2] 522 are unavailable (because there is no operatively linked mobile RAM device and hence no recording medium for docking station [2] 522 to perform mass storage operations). Docking station [3] 524 is operatively linked with the first mobile RAM device 508 configured with the designation of device [0] 543, which has been changed from the previous designation of [1] 513 as shown in FIG. 5A. The host computer 502, which is configured to store data on a device type [0], can engage docking station [3] 524 in storage operations because the associated address:sub-address 3:0 516 can be positively identified as a system that the host computer 502 is configured to perform with which to perform storage operations. In one embodiment, the storage system 500 shown in FIG. 5B, relative to FIG. 5A, illustrates the transfer of the first mobile RAM device 508 moved from docking station [1] 511 to docking station [3] 524 while a second mobile RAM device 540 has been inserted in docking station [1] 511 that has been designated as a virtual device [2] 542. This example illustrates the active mobility of the mobile RAM devices. The map system 509 can remap the reconfigured storage system 500. In another embodiment, the storage system moves the mobile RAM devices via a robotic system (not shown). Alternatively, the mobile RAM devices are moved manually.

As is understood by one skilled in the art, a host computer, such as the host computer 502, generally communicates and stores data in protocol that may be different for alternative devices and media. For example, a tape library protocol includes both a streaming protocol to store data in a linear fashion tailored for tape medium and a media changer protocol adapted to load tape cassettes in tape drives. In the event a docking station, such as docking station [1] 511, positively indicates availability for data storage at a tape drive, such as at address:sub-address 1:0 503 for example, the docking station [1] 511 will be responsive to instructions as if it were a tape storage device that is ready and waiting for data storage commands to commence with functioning as a tape library.

In one embodiment of the present invention, a library could be configured to support both docking stations, such as docking station [3] 524, for use with a mobile RAM device, such as the second mobile RAM device 550, and at least one real (non-virtual) tape drive adapted to store data on real tangible tape cassettes. An example of such a hybrid library supporting storage on both real tape cassettes and virtual tape cassettes is the Spectra Logic T950 library.

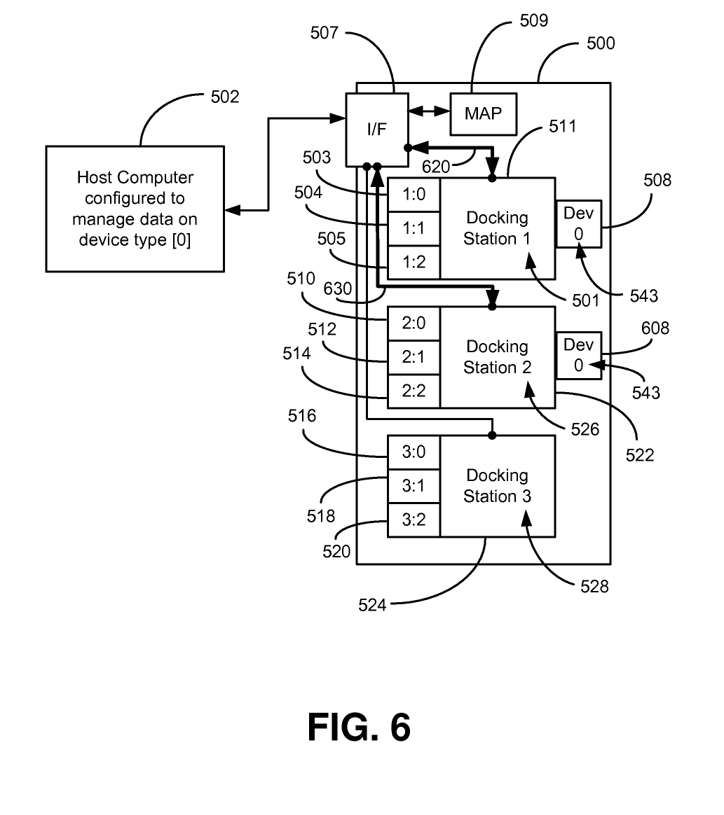

FIG. 6 is yet another alternative embodiment wherein one docking station receives and responds to storage operations from the host computer 502 while another docking station is receiving and responding to different storage operations from the host computer 502. Hence, the storage operations between the host and the two docking stations are occurring in overlapping time duration. Docking station [1] 511 is operatively linked with a first mobile RAM device 508, and docking station [2] 522 is operatively linked with a second mobile RAM device 608. Both the first mobile RAM device 508 and the second mobile RAM device 608 are designated to be device type [0] 543. Both docking stations [1] 511 and [2] 522 are responsive to the host computer 502 as being available for tape storage operations at address:sub-address 1:0 503 and address:sub-address 2:0 510 because both docking station [1] 511 and docking station [2] 522 are designated to operate as virtual tape storage systems. The host computer 502, configured to manage data on device type [0], is shown here performing storage operations 620 and 630 via both docking station [1] 511 and docking station [2] 522, respectively. The storage operations 620 and 630 may occur concurrently on docking station [1] 511 and docking station [2] 522, or during some amount of overlapping time. Docking station [3] 524 does not have a cooperating mobile RAM device 114 and hence registers as being unavailable for storage operations to the host computer 502.

FIG. 7 is an alternative embodiment of the present invention illustrating docking station responsiveness based on available storage space. Herein, docking station [1] 511 is operatively linked with a first mobile RAM device 508 and docking station [2] 522 is operatively linked with a second mobile RAM device 608. Both the first mobile RAM device 511 and the second mobile RAM devices 522 are designated to be device type [0] 503. In this embodiment, the host computer 502 requires storage of 15 GB of data on a device type [0]. Docking station [1] 511 is identified as capable of receiving only 150 MB of data for storage on device type [0] at address:sub-address 1:0 503. Docking station [2] 522 is identified as capable of receiving up to 600 GB of data for storage on device type [0] 543 at address:sub-address 2:0 510. Hence, the host computer 502 engages in storage operations via docking station [2] 522 at address 2:0 510.

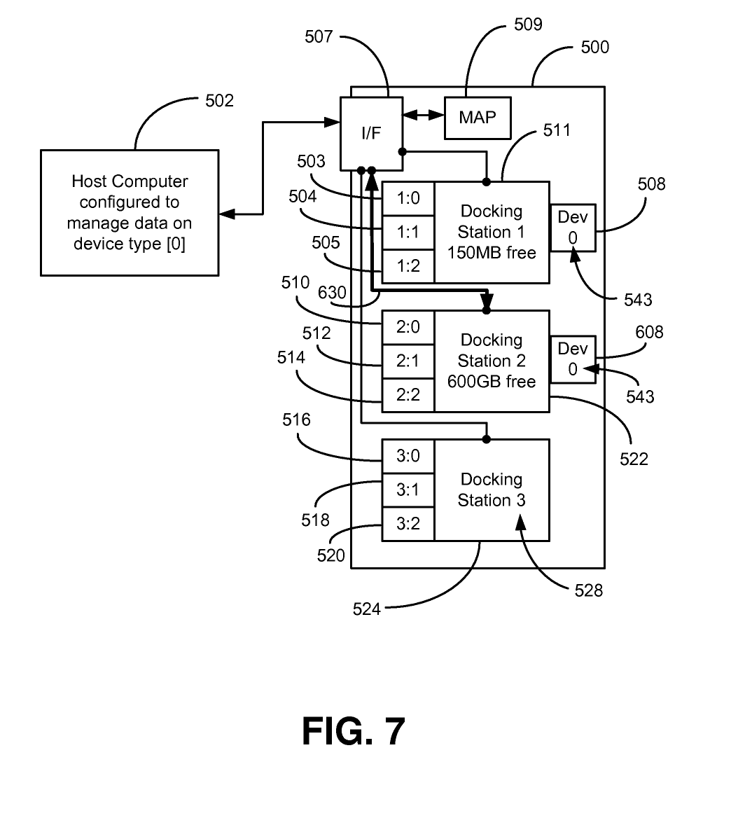

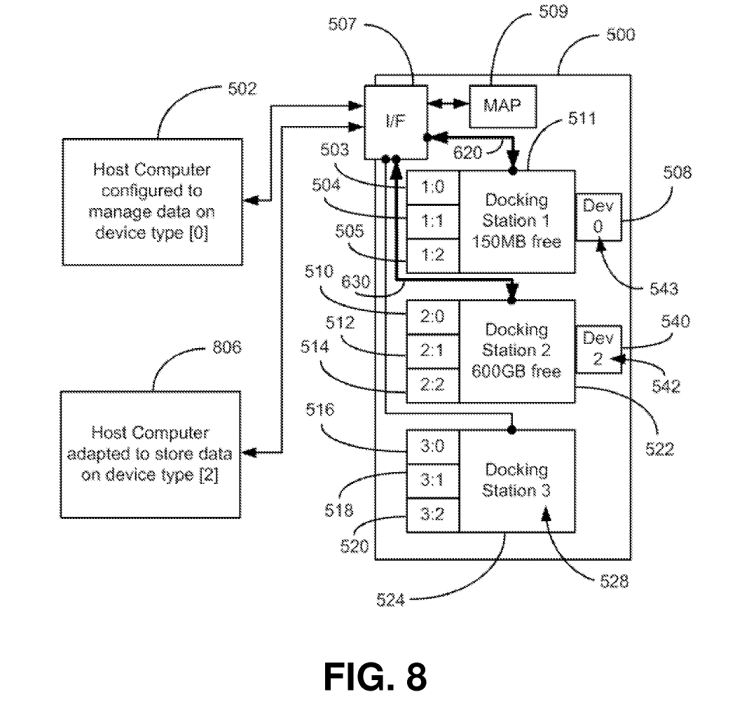

FIG. 8 shows two different host computers 502 and 806 performing storage operations with the storage system 500 at least partially concurrently consistent with some embodiments of the present invention; that is, the first host computer 502 performs storage operations with docking station [1] 511 while the second host computer 806 performs storage operations with docking station [2] 522. Herein, docking station [1] 511 is operatively linked with a first mobile RAM device 508 and docking station [2] 522 is operatively linked with a second mobile RAM device 540. Docking station [1] 511 is available for storage operations at address:sub-address 1:0 503 because the cooperating first mobile RAM device 508 is designated as device [0] 543 configured to store data on media type [0] 543. Docking station [2] 522 is available for storage operations at address:sub-address 2:2 514 because the cooperating second mobile RAM device 540 is designated as device [2] 542 configured to store data on media type [2] 542. As illustratively shown, a first host computer 502 configured to store data on a storage device type [0] is engaged with docking station [1] 511 via the interface processor device 507 and the map system 509 for data storage operations at address 1:0 503 as indicated by the two way arrow 620. A second host computer 806 configured to store data on a storage device type [2] 542 is engaged with docking station [2] 522 for data storage operations at address 2:2 514 via the interface processor device 507 and the map system 509, as indicated by the two way arrow 630. Docking station [3] 524 does not have a cooperating mobile RAM device and hence registers as being unavailable for storage operations.

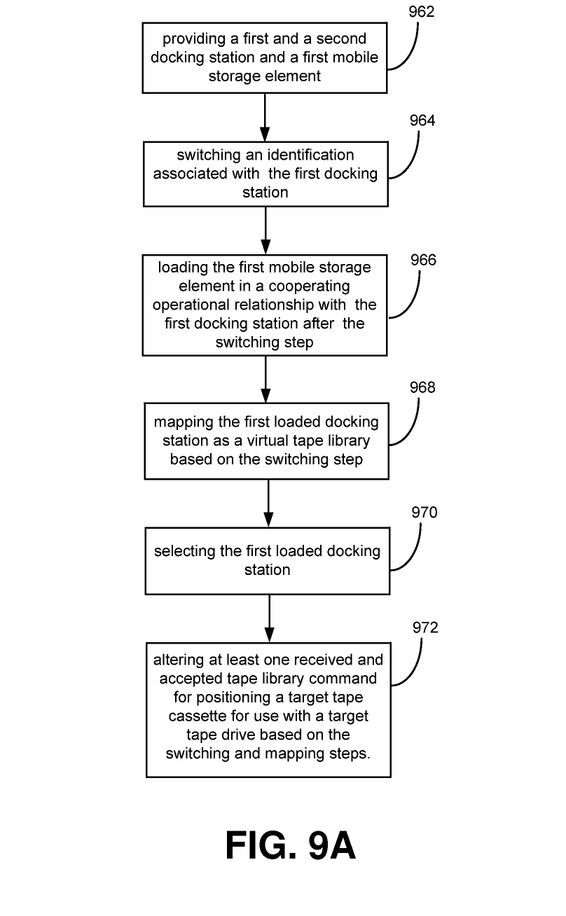

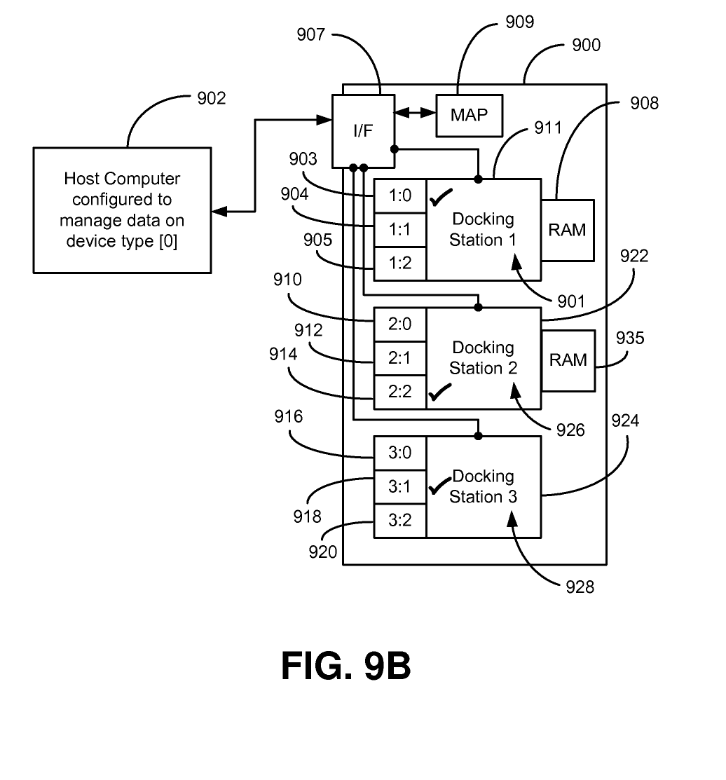

Referring now to FIG. 9A, a block diagram shows method steps to practice an embodiment of the present invention. It should be recognized that the steps presented in the described embodiments of the present invention do not necessarily require any particular sequence. FIG. 9A is used in conjunction with FIG. 9B for purposes of illustration in this embodiment. In step 962, a first docking station 911, a first mobile RAM element 908, a second docking station 922 and a third docking station 924 are provided for use in a storage system 900. In step 964, the identification [0] associated with the first docking station 911 is switched from one identification to a different identification, that being [1:0] 903, as indicated by the check mark at address:sub-address [1:0] 903. For example, the first docking station 911 may have previously been identified as a different device at address:sub-address [1:2] 905 but is currently switched to address:sub-address [1:0] 903. Switching identification of the docking station 911 can be accomplished by the host computer 902, by the storage system 900 which recognizes that the host computer 902 requires storage operations with a specific storage device type, such as device type [0], or optionally, by a manual switch on the docking station 911 wherein the manual switch can switch the function of the storage docking station 911 and the associated RAM device 908. As illustratively shown, the second docking station 922 is designated as a second device type at address:sub-address 2:2 914 and the third docking station 924 is designated as a third device type at address:sub-address 3:1 918. In step 966, the first docking station 911 is loaded with the mobile RAM element 908. Loading herein is the act of inserting a mobile RAM device, such as element 908, in a docking station, such as docking station 911, to form a functionally cooperating pair. A means for the docking station 924 to cooperate with the first mobile RAM element 908 can be via electrical contracts, such as flexible pin and pad arrangements, which supports the mobility of the mobile RAM element 908. Such a configuration is exemplified in FIG. 3 and the associated description. In the embodiment shown in FIG. 9B, the mobile RAM device 908 is loaded in the first docking station [1] 911 as a generic mobile RAM device wherein the designation of device type is accomplished at the docking station 911. In one embodiment, the loading step 966 is preferably accomplished after the switching step 964. In step 968, the first loaded docking station 911 is mapped as a specific storage device type, which, in one embodiment, can be a virtual tape library. In an alternative embodiment, the mapping step 968 is based on the switching identification step 964, and hence, follows step 964. In step 970 the first docking station 911 loaded with RAM element 908 is selected for storage operations for the host computer 902. In the event the docking station 911 is designated to appear virtually as an alternative storage device, such as a tape library, for example, then commands from the host computer 902 may be altered to conform virtually to the alternative storage device.

With reference to FIG. 9B, optional method embodiments can also include further providing a second mobile storage RAM element 935, loading the second mobile storage RAM element 935 in a cooperating operational relationship with the second docking station 922, and after loading the second mobile storage RAM element 935 in the second docking station 922, mapping the second docking station 922 as a loaded second docking station via the map device 909. In an optional embedment, the second docking station 922 can be switched from the illustrated address 2:2 to a different type of media having address 2:0 or 2:1, for example.

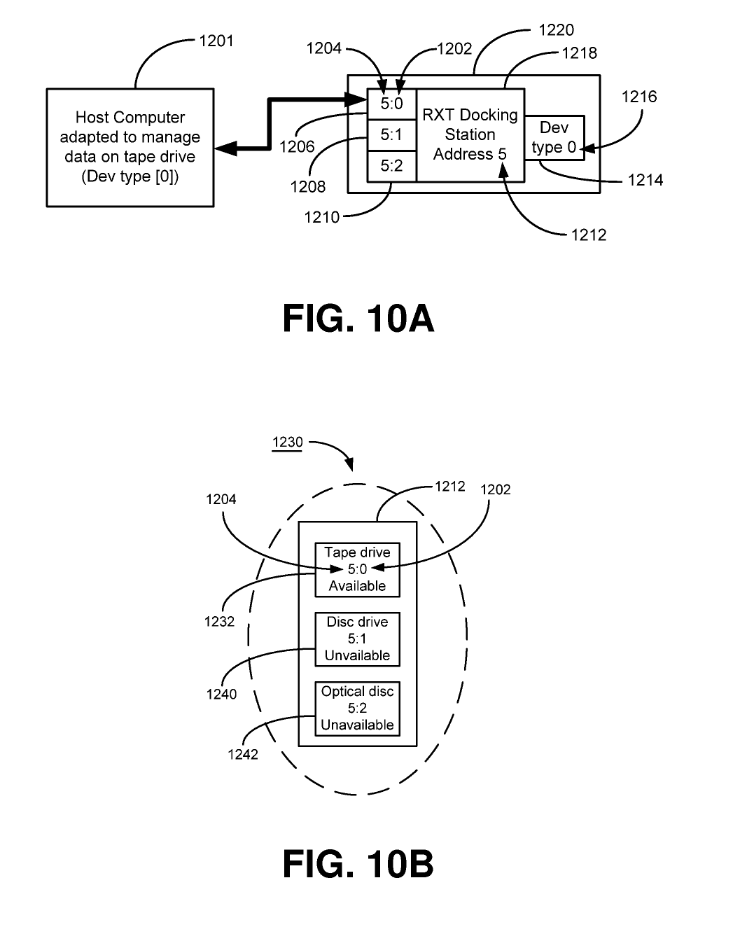

As shown earlier, embodiments of the present invention can be commercially practiced, for example, with a Spectra Logic RXT Bank of Drives storage system 200 of FIG. 2, performing as a storage system 106, for use with RXT disc drive magazines 201. The RXT can comprise one or more RXT docking stations 202 adapted to cooperate with an RXT disc drive magazine 201. As previously described, an RXT disc drive magazine 201 encases a plurality of disc drives, such as 308, which can be provided by Seagate Corporation of Scotts Valley, Calif. As shown in FIG. 10A, a host computer 1201 is capable of initiating commands to communicate with the RXT storage system 200. In one exemplary embodiment, an RXT library 1220 comprises one RXT docking station 1218 that is operatively linked with an RXT disc drive magazine 1214 wherein the RXT docking station 1218 is designated as a tape device 1216. In this embodiment, designation of a tape drive device 1216 is accomplished with a manual switch (not shown) disposed on the RXT docking station 1218 or, in an optional embodiment, on the RXT disc drive magazine 1214. The host computer 1201 will poll the library's 1220 SCSI bus via the interface processor and map system (not shown) searching for devices, in this case the RXT docking station 1218. The host computer 1201 will poll the sub-addresses, or LUNs (such as LUN [0] 1202), of the address (such as address [5] 1212) corresponding to the one RXT docking station 1218 (in the case of multiple addresses, all the addresses may be polled for sub-addresses). FIG. 12B shows a dashed oval 1230 containing virtual devices 1232, 1240 and 1242 at address [5] 1212 associated with the docking station 1218. The virtual devices 1232, 1240 and 1242 include a tape device 1232 with a corresponding SCSI address 5 1204, LUN 0 1202 (5:0 1206), a disc drive device 5:1 1240, and an optical disc device 5:2 1242.

The tape device 1232, disc drive device 1240, and optical disc device 1242 are all at the same address [5] 1204, however, each has a unique LUN, such as LUN [0] 1202. The host 1201 may either create device files or may already have device files associated with each of the virtual devices 1232, 1240 and 1242. When Veritas software, provided by Symantec Corporation of Cupertino, Calif., is used for communication with the docking station 1218, host level device files are used to “talk” to the docking station 1218. In one embodiment, the Veritas software will send a SCSI Inquiry command to the virtual drive devices 1232, 1240 and 1242 to obtain vendor and product identification. The host computer 1201 will then send a mode sense command to obtain geometry corresponding to each virtual drive device 1232, 1240 and 1242 (as emulated by the docking station 1218). Geometry can be the configuration of a virtual system corresponding to each virtual drive device 1232, 1240 and 1242. Using the geometry information, the Veritas software can issue commands such as “Read Element Status” to obtain inventory information, such as availability for storage operations. Upon issuing a “Read Element Status”, each virtual drive device 1232, 1240 and 1242 will return all necessary information for storage operations, such as inventory information, for example. The Veritas software can then “talk” to the tape device 1232 at 5:0 1206, disc drive device 1240 5:1 1206, and optical disc device 1242 5:2 1210 to obtain individual inventory by using a “Test Ready Command”. Because the docking station 1218 is operatively linked with an RXT disc drive magazine 1214 and the RXT disc drive magazine 1218 is designated device [0] 1216 which corresponds to the virtual tape device 1216, a Test Unit Ready command is returned to the host computer 1201 indicating that the tape drive 1232 located at 5:0 1206 is loaded with a cassette and available to perform storage operations. The Test Unit Ready command will indicate that the disc drive device 1240 at 5:1 1208 and the optical disc device 1242 at 5:2 1210 are unavailable for storage operations.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, as described in FIG. 5A, though communication between a host computer 502 and the docking station [1] 511 generally conforms with SCSI protocol, the order and initiation of communication can vary depending on the protocol used, such as fiber channel for example, while still maintaining substantially the same functionality without departing from the scope and spirit of the present invention. Further, though communication is described herein as between the host computer 502 and the docking stations, such as docking station [1] 511, communication can be received by the storage system 500 and channeled to the docking stations without departing from the scope and spirit of the present invention. Finally, although the preferred embodiments described herein are directed to disc drive systems, such as the disc drive magazine 201, and related technology, it will be appreciated by those skilled in the art that the teachings of the present invention can be applied to other systems, without departing from the spirit and scope of the present invention.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed and as defined in the appended claims.

What is claimed is:

1. A storage system comprising:
an interface processor device that interfaces between said storage system and a host;
a first mobile storage element;
a first docking station adapted to receive said first mobile storage element to form a functional pair wherein said functional pair can perform storage operations;
a switch system capable of switching said first docking station to appear virtually to said host as a first tape storage system;
a map system that is adapted to map said first docking station as either said docking station or said virtual tape storage system based on the switching state of said switch system.

2. The storage system of claim 1 wherein said functional pair appears virtually to said host as a first tape storage system that is ready to access at least one target tape cartridge for at least one tape drive

3. The storage system of claim 2 wherein functional pair appears virtually to said host via a map generated by said map system.

4. The storage system of claim 1 wherein said first tape storage system is selected from the group consisting of: a first tape drive, a plurality of tape drives, a first tape library, a first partition of a tape library possessing a plurality of tape drives.

5. The storage system of claim 1 further comprising a second docking station linked with a second mobile storage element as a second functional pair wherein when said second docking station is switched to appear virtually to said host as a second tape storage system.

6. The storage system of claim 5 wherein said map system maps said second docking station as at least a second tape drive that is available for storage operations on at least a second tape cassette.

7. The storage system of claim 5 wherein said first mobile storage element is incompatible with said second docking station.

8. The storage system of claim 5 wherein said switch system comprises a switching element located at each of said docking stations.

9. The storage system of claim 1 wherein said first docking station is functionally paired with said first mobile storage element and switched to appear to said host as first docking station and first mobile storage element.

10. The storage system of claim 9 wherein said switching element is manually toggled.

11. The storage system of claim 1 wherein said first mobile storage element and said first docking station are not linked as said functional pair via any command initiated by said host.

12. The storage system of claim 1 further comprising a third docking station capable of being loaded with a third mobile storage element, said first docking station also capable of being loaded with said third mobile storage element.

13. The storage system of claim 1 further comprising at least one actual tape drive capable of being loaded with at least one actual tape cassette.

14. The storage system of claim 1 further comprising a second mobile storage element that when loaded in a cooperating relationship with said second docking station is mapped as a first tape drive with access to said second target tape cassette.

15. A method for using a storage system comprising:
providing a first and a second docking station and a first mobile storage element;
switching an identification associated with said first docking station;
loading said first mobile storage element in a cooperating operational relationship with said first docking station after said switching step;
mapping said first loaded docking station as a virtual tape library based on said switching identification step.

16. The method of claim 15 further comprising providing a second mobile storage element, loading said second mobile storage element in a cooperating operational relationship with said second docking station, and after said loading step, mapping said second docking station as a loaded second docking station.

17. The method of claim 15 further comprising switching identification of said second docking station; providing a second mobile storage element, loading said second mobile storage element in a cooperating relationship with said second docking station after said switching identification of said second docking station step; and mapping said loaded second docking station as a second virtual tape library based on said switching identification of said second docking station step.

18. The method of claim 15 further comprising selecting said first loaded docking station;
altering at least one received and accepted tape library command for positioning a target tape cassette for use with a target tape drive based on said switching and mapping steps.

19. A data storage system comprising:
at least one mobile storage element;
at least one docking station that includes a means for cooperating with an associated one of said at least one mobile storage element to store data for a host computer;
a switching means linked to said at least one docking station for switching an identification associated with said at least one docking station to a virtual tape library, wherein a switching function of said switching means is not initiated by said host.

20. The data storage system of claim 19 wherein said switching means capable of switching said identification from said virtual tape library to different data storage system.
